(19) United States
(12) Patent Application Publication
(10) Pub. No.: US 2005/0116063 A1
(43) Pub. Date: Jun. 2, 2005

(54) Sprayer device having rotary control member

(76) Inventor: Chin Chung Wang, Chang Hua (TW)

Correspondence Address: CHARLES E. BAXLEY, ESQ., 90 JOHN STREET, 3RD. FLOOR, NEW YORK, NY, 10038, US

(21) Appl. No.: 10/724,287

(22) Filed: Nov. 27, 2003

(51) Int. Cl. B05B 1/34; B05B 3/04; B05B 3/16; A62C 31/02

(52) U.S. Cl. 239/380; 239/383; 239/381

(57) ABSTRACT

A sprayer device includes a housing having a water inlet, and having a front opening, a rotary member is rotatably received in the housing and has a number of cavities and outlets communicating with each other, and to be selectively aligned with the front opening and the inlet of the housing, to allow the water to selectively flow out through the front opening of the housing via either of the outlets of the rotary member. The housing includes a mouth communicating with the inlet, to selectively align with either of the cavities of the rotary member, and to prevent the users from contacting with the water or chemical materials flowing out of the sprayer device.

### BACKGROUND OF THE INVENTION

1. Field of the Invention

The present invention relates to a sprayer device, and more particularly to a sprayer device having an easily control structure or inner rotary control member for allowing the sprayer device to be easily controlled and operated by the users.

2. Description of the Prior Art

Various kinds of typical sprayer devices have been developed and comprise a sprayer gun body, and a control nozzle rotatably attached to the front portion of the sprayer gun body, and rotatable about a pivot axle that is parallel to the longitudinal direction or axis of the sprayer gun body, in order to select the required spraying patterns.

For example, U.S. Pat. No. 5,501,400 to Kuo, U.S. Pat. No. 5,566,886 to Wang, and U.S. Pat. No. 5,690,312 to Yang disclose three of the typical sprayer devices each also comprising a control nozzle rotatably attached to the front portion of the sprayer gun body, and rotatable about a pivot axle that is parallel to the longitudinal direction or axis of the sprayer gun body.

It is to be noted that the control nozzle is disposed or arranged perpendicular to the sprayer gun body, and it will be difficult for the users to rotate the control nozzle relative to the sprayer gun body, about the pivot axle, because the control nozzle is disposed in the front portion of the sprayer gun body.

In addition, in operation, the users have to contact and then to rotate the control nozzle relative to the sprayer gun body, in order to select the required spraying patterns. However, when chemical or pesticide or poisonous materials are added or included into the liquid to be sprayed through the sprayer device, the users may also be contacted with the chemical or pesticide or poisonous materials directly, and may be hurt by the chemical or pesticide or poisonous materials.

The present invention has arisen to mitigate and/or obviate the afore-described disadvantages of the conventional sprayer devices.

### SUMMARY OF THE INVENTION

The primary objective of the present invention is to provide a sprayer device including an easily control structure or device having an inner rotary control member for allowing the sprayer device to be easily controlled and operated by the users.

The other objective of the present invention is to provide a sprayer device including an easily control structure or device for preventing the users from contacting with the water or the chemical or pesticide or poisonous materials flowing out of the sprayer device.

In accordance with one aspect of the invention, there is provided a sprayer device comprising a housing including a chamber formed therein, and including an inlet for coupling to a water reservoir and to receive water therefrom, and including a front opening formed therein for outward flowing of the water, and a rotary member rotatably received in the housing, the rotary member including a plurality of cavities formed therein, and including an outer peripheral portion having a plurality of outlets formed therein and communicating with the cavities thereof respectively, and to be selectively aligned with the front opening of the housing, to allow the water to selectively flow out through the front opening of the housing via either of the outlets of the rotary member. The housing includes a mouth communicating with the inlet thereof, for receiving the water from the inlet thereof, the mouth is provided to selectively align with either of the cavities of the rotary member, to allow the water to selectively flow out through either of the outlets of the rotary member, and for preventing the users from contacting with the water or the chemical or pesticide or poisonous materials flowing out of the sprayer device.

The housing includes a water passage formed therein and communicating between the inlet and the mouth of the housing. The housing includes a partition provided in the chamber thereof, to separate the inlet and the chamber thereof from each other, the water passage of the housing includes one end communicating with the inlet of the housing.

The rotary member includes is rotatably secured in the housing with an axle. The axle is extended from the housing, and the rotary member includes a pin extended therefrom and engaged into the axle of the housing.

A device may further be provided to retain the rotary member at selected angular position relative to the housing. The housing includes a spring-biased projection received therein, to engage with the rotary member, and to position the rotary member relative to the housing at selected angular position relative to the housing.

The rotary member includes an aperture formed therein to selectively align with the mouth of the housing. The housing includes a water pathway formed therein and having a port formed therein, and the rotary member includes a channel formed therein and communicating with the aperture thereof and having an exit for selectively aligning with the port of the housing.

The housing includes a front portion having a head attached thereto, the head includes a rear plate having a passageway formed therein for selectively aligning with the channel of the rotary member, to allow the water from the aperture of the rotary member to flow out through the channel of the rotary member and the water pathway of the housing and the passageway of the rear plate of the head.

The head includes a front plate having a plurality of perforations formed therein. The head includes a partition formed therein and having at least one hole formed therein.

A knob may further be provided and attached to the rotary member, to rotate the rotary member relative to the housing with the knob. A shank may further be provided and secured between the rotary member and the knob, to allow the rotary member to be rotated relative to the housing with the knob.

The rotary member includes a recess formed therein to receive the shank, and includes at least one notch formed therein, the shank includes at least one extension extended therefrom and engaged into the notch of the rotary member, to solidly secure the shank to the rotary member. The shank includes a peripheral flange extended therefrom for engaging with the housing, to rotatably anchor the shank to the housing.

A device may further be provided to retain the knob at selected angular position relative to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a sprayer device in accordance with the present invention;

FIG. 2 is an exploded view of the sprayer device;

FIG. 3 is a front perspective view of a front cover of the sprayer device;

FIG. 4 is an exploded view of a rotary member of the sprayer device;

FIG. 5 is a front schematic view of the sprayer device, having the front cover removed for showing the inner structure of the sprayer device;

FIG. 6 is a partial cross sectional view taken along lines 6-6 of FIG. 5;

FIG. 7 is a partial cross sectional view taken along lines 7-7 of FIG. 8; and

FIG. 8 is a partial cross sectional view taken along lines 8-8 of FIG. 7.

### DETAILED DESCRIPTION OF THE PREFERRED EMBODIMENT

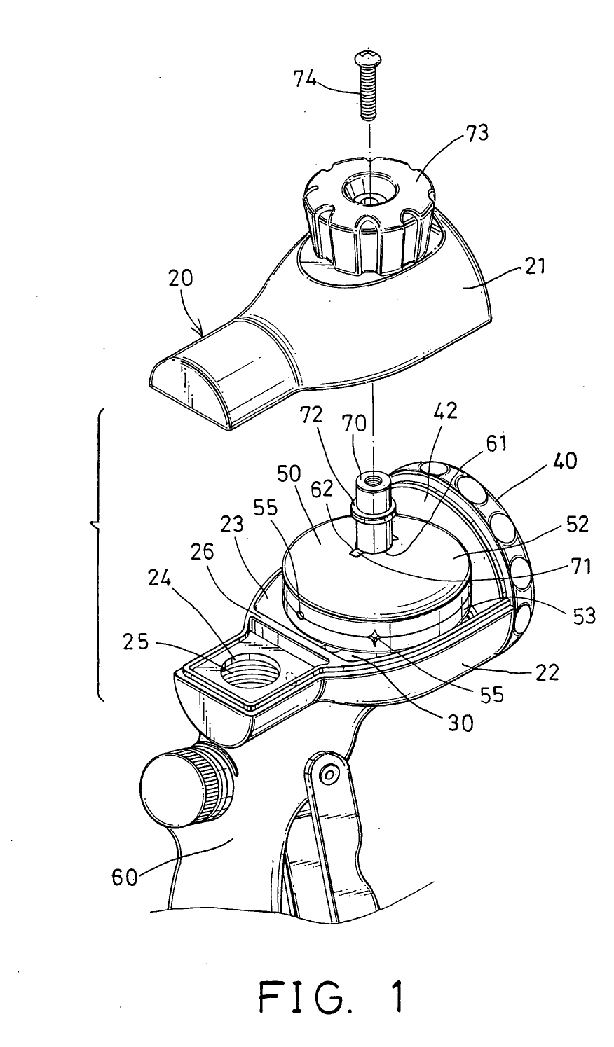

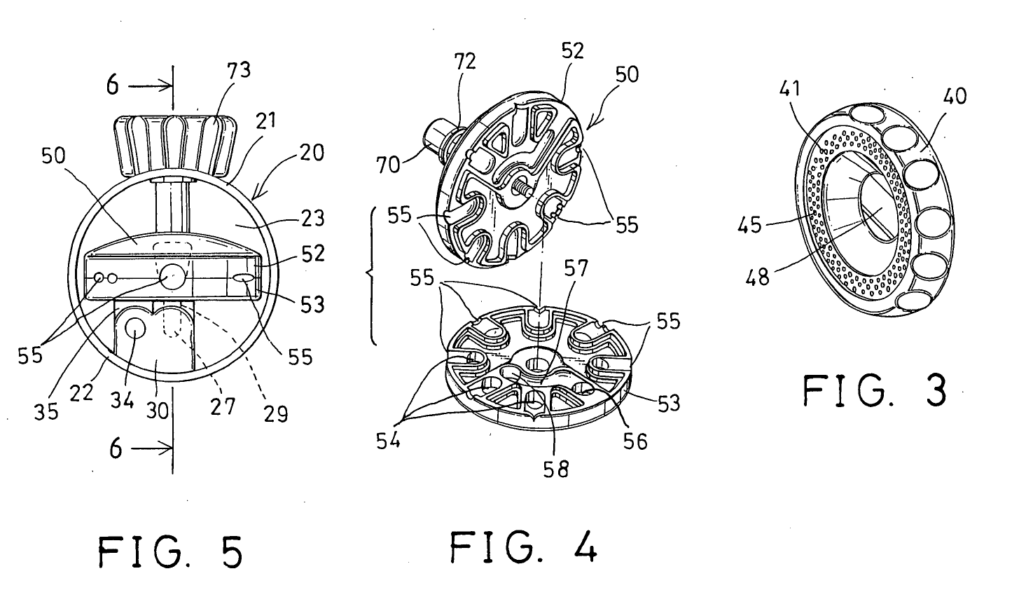

Referring to the drawings, and initially to FIGS. 1-6, a sprayer device in accordance with the present invention comprises a housing 20 including such as two housing members 21, 22 to be secured together with fasteners (not shown), adhesive materials, or by welding processes, and including a chamber 23 formed therein.

The housing 20 includes an inlet 24 having an inner thread 25 formed or provided therein for coupling to water reservoirs with such as hoses (not shown), or sprayer guns 60 (FIGS. 1, 2, 6, 7), and includes a partition 26 provided therein to separate the chamber 23 and the inlet 24 from each other.

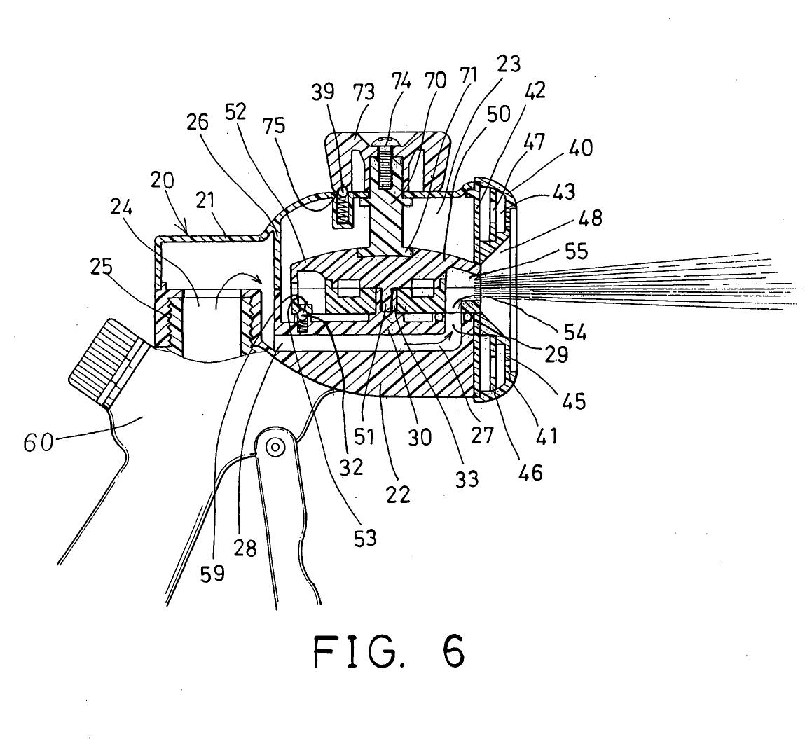

The housing 20 includes a water passage 27 formed in a lower portion or a base 30 thereof (FIG. 6), and having one end 28 communicating with the inlet 24 of the housing 20, and/or formed through the partition 26, for allowing water to flow into the water passage 27 of the housing 20 via the inlet 24 of the housing 20. The water passage 27 of the housing 20 includes a mouth 29 formed or provided in the other end thereof, and opened and communicating with the chamber 23 of the housing 20.

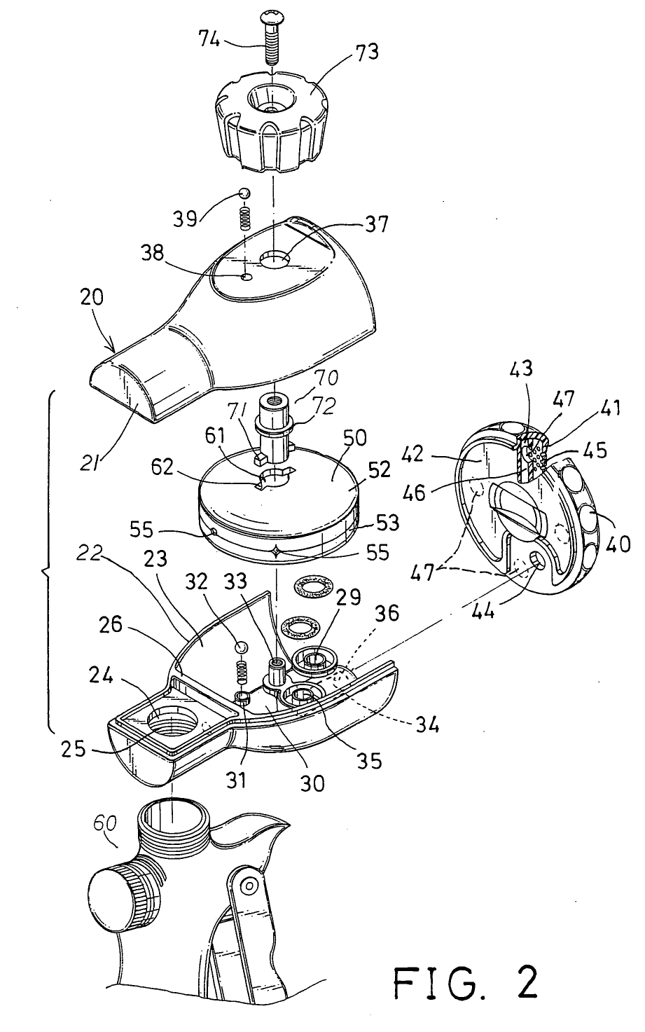

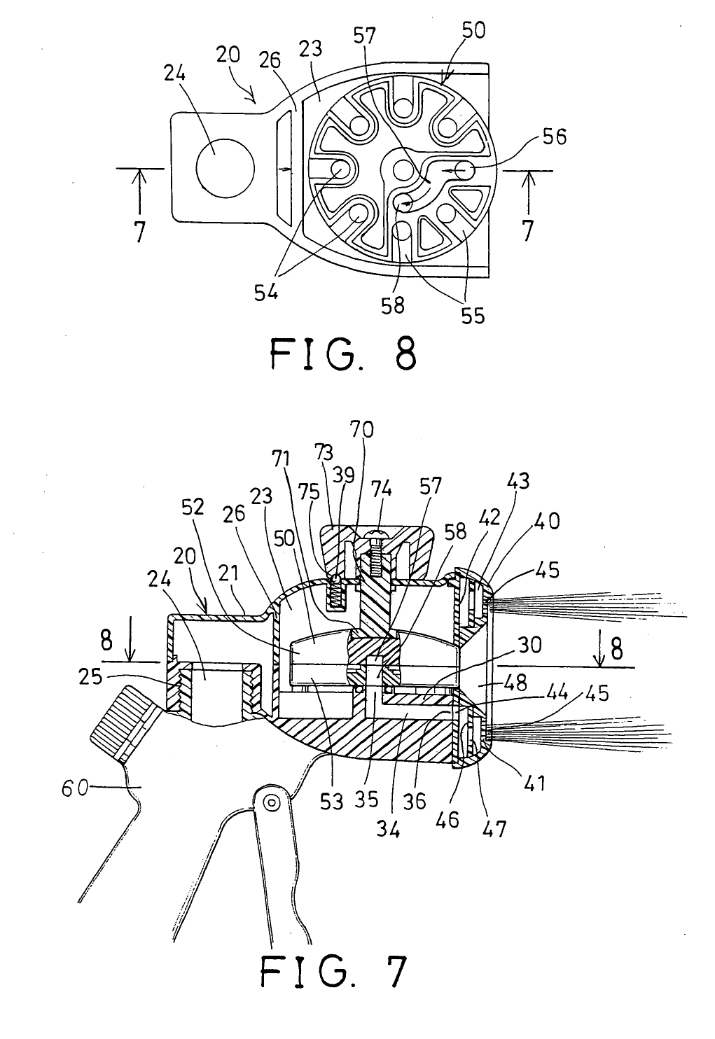

The housing 20 further includes a water pathway 34 formed in the lower portion or in the base 30 thereof, and having a port 35 formed or provided in one end thereof, and communicating with the chamber 23 of the housing 20, and having the other end 36 opened forwardly (FIG. 7). The mouth 29 and the port 35 are formed or provided on top of the base 30 of the housing 20 (FIG. 2).

The housing 20 further includes a cavity 31 formed in the lower portion or in the base 30 thereof, for receiving a spring-biased projection 32, and includes a hub or an axle 33 extended upwardly from the base 30 of the housing 20, for rotatably receiving or supporting a rotary member 50 which will be described in further details hereinafter.

The housing 20 further includes a head 40 attached or secured to the front portion thereof with fasteners (not shown), adhesive materials, or by welding processes. The head 40 includes a chamber 43 formed between a front plate 41 and a rear plate 42, and a passageway 44 formed in the rear plate 42 and aligned with the water pathway 34 of the housing 20 (FIG. 7), to receive water from the inlet 24 of the housing 20.

The head 40 includes a number of perforations 45 formed in the front plate 41 for allowing the water to flow out through the perforations 45 of the head 40. A partition 46 may further be provided and engaged in the head 40 or disposed between the front plate 41 and the rear plate 42, and includes one or more holes 47 formed therein for guiding the water to flow from the passageway 44 of the rear plate 42 through the perforations 45 of the front plate 41 of the head 40. The head 40 includes a middle or center or front opening 48 formed therein.

The rotary member 50 is rotatably received in the housing 20 with the axle 33 of the housing 20, and/or includes a pin 51 rotatably engaged into the axle 33 (FIG. 6), to rotatably attach the rotary member 50 to the housing 20. The rotary member 50 may also be formed or made by such as two members 52, 53 to be secured together with fasteners (not shown), adhesive materials, or by welding processes.

The rotary member 50 includes a number of cavities 54 and an aperture 56 formed in the bottom portion thereof and formed around the axle 31 or the pin 51 thereof, and includes a number of outlets 55 of different patterns formed in the outer peripheral portion thereof and communicating with the cavities 54 of the rotary member 50 respectively.

Either of the cavities 54 of the rotary member 50 may be selectively aligned with the mouth 29 of the housing 20 (FIG. 6), to allow the water to flow out through either of the outlets 55 of the rotary member 50 in different spraying patterns respectively, due to the different patterns of the outlets 55 of the rotary member 50.

The aperture 56 of the rotary member 50 is also formed around the axle 31 or the pin 51 of the rotary member 50, and may also be selectively aligned with the mouth 29 of the housing 20. However, the rotary member 50 has no outlets 55 communicating with the aperture 56 of the rotary member 50 (FIGS. 4, 8).

Instead, the rotary member 50 includes a channel 57 formed therein and communicating with the aperture 56 of the rotary member 50 and having an exit 58 for selectively aligning with the port 35 of the housing 20 (FIG. 7), and thus for allow the water to flow out through the water pathway 34 of the housing 20 via the inlet 24 and the water passage 27 and the mouth 29 of the housing 20 and the channel 57 of the rotary member 50.

In operation, as shown in FIGS. 5-6, either of the outlets 55 of different patterns of the rotary member 50 may be alternatively or selectively aligned with the middle or center opening 48 of the head 40 of the housing 20, to allow the water to alternatively or selectively flow out through the middle or center opening 48 of the head 40 of the housing 20 via either of the outlets 55 of the rotary member 50, when the rotary member 50 is rotated relative to the housing 20 and when the respective cavities 54 of the rotary member 50 are selectively aligned with the mouth 29 of the housing 20.

As shown in FIGS. 7-8, when the aperture 56 of the rotary member 50 is rotated to be aligned with the mouth 29 of the housing 20, no outlets 55 are communicating with the aperture 56 of the rotary member 50 such that the middle or center opening 48 of the head 40 of the housing 20 will be blocked by the rotary member 50, and such that the water will not flow out through the middle or center opening 48 of the head 40 of the housing 20.

Instead, the water flowing through the aperture 56 of the rotary member 50 may flow through the channel 57 of the rotary member 50, and then through the water pathway 34 of the housing 20, and then may flow into the chamber 43 of the head 40 via the passageway 44 of the rear plate 42 of the head 40, and then may flow out through the perforations 45 of the head 40.

The water from the inlet 24 of the housing 20 may thus flow out through either of the outlets 55 of the rotary member 50 when the respective cavities 54 of the rotary member 50 are selectively aligned with the mouth 29 of the housing 20, or selectively flow out through the perforations 45 of the head 40 when the aperture 56 of the rotary member 50 is selectively aligned with the mouth 29 of the housing 20.

The rotary member 50 includes a number of depressions 49 formed in the bottom portion thereof (FIG. 6) for selectively receiving the spring-biased projection 32 of the housing 20, in order to position the rotary member 50 relative to the housing 20 and the head 40, and to maintain the alignment of the mouth 29 of the housing 20 with either of the cavities 54 of the rotary member 50 or the aperture 56 of the rotary member 50.

The rotary member 50 further includes a recess 61 and one or more notches 62 formed in the upper portion thereof (FIGS. 1, 2 and 6-7). A shank 70 includes a lower portion engaged into the recess 61 of the rotary member 50, and includes one or more extensions 71 extended therefrom and engaged into the notches 62 of the rotary member 50, to solidly secure the shank 70 to the rotary member 50, and to prevent the shank 70 from being rotated relative to the rotary member 50.

The shank 70 preferably includes a peripheral flange 72 provided thereon for engaging with the housing 20 (FIG. 6), to rotatably anchor the shank 70 to the housing 20, and to prevent the shank 70 from being disengaged from the housing 20. The upper portion of the shank 70 may be extended outward through a hole 37 of the housing 20 and secured to a knob 73 with such as one or more fasteners 74, to allow the rotary member 50 to be rotated relative to the housing 20 by the knob 73.

The upper portion of the housing 20 includes a depression 38 formed therein (FIGS. 2, 6, 7), to receive another spring-biased projection 39, and to selectively engage with a number of bottom cavities 75 of the knob 73, to anchor or to position the knob 73 at the required or selected angular position relative to the housing 20.

The engagement of the spring-biased projection 39 of the housing 20 with either of the bottom cavities 75 of the knob 73 may also be selectively used to retain the alignment of the mouth 29 of the housing 20 with either of the cavities 54 of the rotary member 50 or the aperture 56 of the rotary member 50.

It is to be noted that the rotary member 50 is freely and rotatably received in the housing 20, and includes a number of cavities 54 and an aperture 56 and a number of outlets 55 of different patterns formed or provided therearound, for allowing a number of spraying patterns to be selected by the users. None of the conventional sprayer devices suggest to provide a rotary member rotatably received in a housing and having a number of spraying patterns to be freely selected by the users.

In addition, the rotary member 50 may be rotated relative to the housing 20 with the knob 73, and the knob 73 is provided on the upper portion of the housing 20, such that the rotary member 50 may be rotated by the users with the knob 70 without contacting the rotary member 50, and such that the users will not contact with the water and/or the chemical or pesticide or poisonous materials flowing out through the rotary member 50, and such that the users will not be hurt by the chemical or pesticide or poisonous materials.

Accordingly, the sprayer device includes an easily control structure or device for allowing the sprayer device to be easily controlled and operated by the users, and for preventing the users from contacting with the water or the chemical or pesticide or poisonous materials flowing out of the sprayer device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A sprayer device comprising:
a housing including a chamber formed therein, and including an inlet for coupling to a water reservoir and to receive water therefrom, and including a front opening formed therein for outward flowing of the water,
a rotary member rotatably received in said housing, said rotary member including a plurality of cavities formed therein, and including an outer peripheral portion having a plurality of outlets formed therein and communicating with said cavities thereof respectively, and to be selectively aligned with said front opening of said housing, to allow the water to selectively flow out through said front opening of said housing via either of said outlets of said rotary member, and
said housing including a mouth communicating with said inlet thereof, for receiving the water from said inlet thereof, said mouth being provided to selectively align with either of said cavities of said rotary member, to allow the water to selectively flow out through either of said outlets of said rotary member.

2. The sprayer device as claimed in claim 1, wherein said housing includes a water passage formed therein and communicating between said inlet and said mouth of said housing.

3. The sprayer device as claimed in claim 2, wherein said housing includes a partition provided in said chamber thereof, to separate said inlet and said chamber thereof from each other, said water passage of said housing includes one end communicating with said inlet of said housing.

4. The sprayer device as claimed in claim 1, wherein said rotary member includes is rotatably secured in said housing with an axle.

5. The sprayer device as claimed in claim 4, wherein said axle is extended from said housing, and said rotary member includes a pin extended therefrom and engaged into said axle of said housing.

6. The sprayer device as claimed in claim 1 further comprising means to retain said rotary member at selected angular position relative to said housing.

7. The sprayer device as claimed in claim 6, wherein said housing includes a spring-biased projection received therein, to engage with said rotary member, and to position said rotary member relative to said housing at selected angular position relative to said housing.

8. The sprayer device as claimed in claim 1, wherein said rotary member includes an aperture formed therein to selectively align with said mouth of said housing.

9. The sprayer device as claimed in claim 8, wherein said housing includes a water pathway formed therein and having a port formed therein, and said rotary member includes a channel formed therein and communicating with said aperture thereof and having an exit for selectively aligning with said port of said housing.

10. The sprayer device as claimed in claim 9, wherein said housing includes a front portion having a head attached thereto, said head includes a rear plate having a passageway formed therein for selectively aligning with said channel of said rotary member, to allow the water from said aperture of said rotary member to flow out through said channel of said rotary member and said water pathway of said housing and said passageway of said rear plate of said head.

11. The sprayer device as claimed in claim 10, wherein said head includes a front plate having a plurality of perforations formed therein.

12. The sprayer device as claimed in claim 10, wherein said head includes a partition formed therein and having at least one hole formed therein.

13. The sprayer device as claimed in claim 1 further comprising a knob attached to said rotary member, to rotate said rotary member relative to said housing with said knob.

14. The sprayer device as claimed in claim 13 further comprising a shank secured between said rotary member and said knob, to allow said rotary member to be rotated relative to said housing with said knob.

15. The sprayer device as claimed in claim 14, wherein said rotary member includes a recess formed therein to receive said shank, and includes at least one notch formed therein, said shank includes at least one extension extended therefrom and engaged into said at least one notch of said rotary member, to solidly secure said shank to said rotary member.

16. The sprayer device as claimed in claim 14, wherein said shank includes a peripheral flange extended therefrom for engaging with said housing, to rotatably anchor said shank to said housing.

17. The sprayer device as claimed in claim 13 further comprising means to retain said knob at selected angular position relative to said housing.
